(19) United States
(12) Patent Application Publication
(10) Pub. No.: US 2007/0247645 A1
(43) Pub. Date: Oct. 25, 2007

(54) Method for Automatically Editing Video Sequences and Camera for Implementing the Method

(76) Inventors: Nicolas P. Touchard, Suresnes (FR); Christophe E. Papin, Bois Colombes (FR); Olivier L. Seignol, Grenoble (FR); Jean-Marie Vau, Paris (FR)

Correspondence Address: Patent Legal Staff;Eastman Kodak Company, 343 State Street, Rochester, NY, 14650-2201, US

(21) Appl. No.: 10/599,629

(22) PCT Filed: Mar. 24, 2005
(86) PCT No.: PCT/EP05/03138

§ 371 Date: Jun. 26, 2007

(30) Foreign Application Priority Data
Apr. 7, 2004 (FR) 0403628

(51) Int. Cl. H04N 1/00

(52) U.S. Cl. 358/1.6

(57) ABSTRACT

A method for automatically editing video sequences to produce lenticular grid hardcopies, includes the selection of a first set of images in a shot image sequence; the assignment to each image of the image set of an individual quality factor as a function of image characteristics; the selection of at least one new image set by replacing at least one image of the previously selected image set by a new image of the shot sequence; the preparation of image data to form a lenticular grid hardcopy, based on an image set taken from among the previously selected image sets and with the highest overall quality factor, the overall quality factor being a function of the individual quality factors of the images of each selected image set.

### FIELD OF THE INVENTION

The present invention relates to a method for automatically editing video sequences based on shot sequences, in order to produce lenticular grid hardcopies. Lenticular grid hardcopy means a photographic hardcopy in which several images are combined and linked to a lens grid. The lens grid enables selective observation of the images according to an observation angle of the hardcopy. By continuously varying the observation angle, rotation of the hardcopy enables the images to be run through and thus the shot sequence to be simulated.

The invention has applications especially for digital cameras such as photographic cameras, mobile phones or other portable multimedia equipment provided with an image sensor.

### BACKGROUND OF THE INVENTION

A number of digital photographic cameras propose an image-by-image capture mode, and a burst capture mode enabling the capture of a sequence of images. In the latter case, the images are captured at regular intervals, for as long as the user holds the release button down.

The image sequences are then viewed either on the camera's control screen, or on a computer screen. They then appear as short motion-picture or video sequences.

Another solution to view the shot sequences consists in producing hardcopy and more precisely lenticular grid hardcopies. As mentioned in the introduction, lenticular grid hardcopy comprises many interlaced images to form a single image linked to a lens grid. The user can vary the observation angle of the lenticular grid hardcopy, to make each of the images appear successively. When the interlacing of the images is designed to make various images of a shot sequence appear in the shooting order, the user can view the sequence by pivoting the lenticular grid hardcopy manually.

The user can even vary the apparent speed of the sequence by pivoting the hardcopy more or less quickly.

The lenticular image hardcopies are formed from a fairly small number of images. This number is generally about 25 to 30 images. The top limit of the number of images is determined by the resolution of the printing system and especially by the number of image lines printable per elementary lens. Given this limitation, only fairly short sequences can be fully reproduced.

The transfer of the sequences onto the lenticular grid hardcopies can have several difficulties. A sequence not containing sufficient movement is more suited to a fixed image and does not justify the use of a lenticular grid. Conversely, a sequence containing too much movement, i.e. where the successive images are too different from one another, will tend to appear with poor image quality. This is due to partial overlapping of the interlaced images. In this matter one can refer to the document (1) whose references are set out at the end of the description.

Other parameters, in particular linked to respecting the rate of the sequence's images, to the exposure quality and sharpness of individual images of the sequence, also have a strong influence on the final quality of the lenticular grid hardcopy.

The document (1) proposes a camera device enabling the user to preview on a small control screen the sequence as it will be reproduced by the lenticular grid medium. The device also enables the user to modify the image sequence that will be used to form a lenticular grid hardcopy. In particular it enables the choice of the sequence start and end, the amount of movement it contains, its quality and possibly a set of images to be retained. The option offered to the user to more or less edit an image sequence before proceeding to its transfer onto a medium, aims at improving the quality. However, this operation requires the user to devote some time to viewing and correcting the sequence to be retained. The ease of implementing the editing also depends on the quality of the data input interface provided by the camera.

### SUMMARY OF THE INVENTION

The object of the present invention is to propose an automatic editing method of video sequences not requiring a user's intervention.

Another object is to propose such a method capable of being implemented on very summary camera equipment, such as mobile phones with built-in image sensor, or more generally equipment not having a conformable control interface.

Another object is to propose a method enabling the quality of lenticular grid hardcopies to be improved while enabling a considerable amount of movement in the video sequences used to produce the hardcopies. The term “amount of movement” means the presence of images in the sequence, sufficiently different from one another, to cause an impression of movement when observing the lenticular grid that is pivoted.

It is also an object of the invention to propose a camera for implementing the method.

More precisely it is an object of the invention to provide an automatic editing method of video sequences to produce lenticular grid hardcopies based on shot sequences produced by a digital camera. The method comprises:

a) the selection of a first set of images in a shot image sequence,

b) the assignment to each image of the image set of an individual quality factor as a function of image characteristics,

c) the selection of at least one new image set by replacing at least one image of the previously selected image set by a new image of the shot sequence, and absent from the previously selected set,

d) the preparation of image data to form a lenticular grid hardcopy, based on an image set taken from among the previously selected image sets and with the highest overall quality factor, the overall quality factor being a function of the individual quality factors of the images of each selected image set.

The selection of an image set, and in particular the selection of the first image set can occur by retaining a subset of images of the shot sequence. When the number of images of the shot sequence is more than the number of images that can be combined in a lenticular grid hardcopy, which is most often the case, only one image out of two may be retained, or one image out of three, or in general one image out of N, N being an integer.

While this is not an essential characteristic, the images are preferably selected in a regular order. That is to say, a constant number of non-selected images respectively separates two selected images in the initial shot sequence. Following a regular order enables the natural aspect of the movements of the recorded scene to be kept.

An important characteristic of the invention is the taking into account of a quality factor of the selected images. The individual quality factor can correspond to one or more image characteristics. These are characteristics specific to the image, i.e. linked to the image content, or again characteristics taking into account both the image and the neighboring images of the shot sequence. Image specific characteristics are for example the sharpness, the sharpness of an interest zone of the image, the exposure, the contrast, the color balance, the presence or absence of interest zones, the presence or absence of faces, the centering in relation to an interest zone, etc.

The interest zone of the image means a zone that complies with a number of predefined criteria. This is, in its simplest expression, a zone with color contrasts exceeding a certain value. This enables uniform areas of sky or ground to be rejected. In a more sophisticated way, interest zones can be defined by the fact that they contain a human face. The presence of a face can be detected in different ways. It is performed by the detection of skin colors, and/or by the detection of geometric structures characteristic of the nose or eyes. Other criteria can be used to define interest zones. The detection of interest zones in an image is a known technique.

To the image specific characteristics, capable of being used to establish the individual quality factor can be added characteristics that take into account neighboring images. Such a characteristic can be the amount of movement of an image in relation to the neighboring images of the shot sequence.

A small amount of movement means that the image is more or less identical to the previous image or to the next image. A large amount of movement means that at least some elements of the image are displaced or transformed significantly from one image to the next or from one image to the previous. Since images of shot sequences are generally taken at regular rates, a rapid movement or displacement corresponds to a large amount of movement.

For a lenticular grid hardcopy, it is generally required that the amount of movement of one image in relation to the previous or next images is neither too little, to favor the dynamic effect, or too large, to favor the image quality. A high quality factor can thus be used when the amount of movement of an image is contained within a set range. A lower quality factor is assigned to the image when its amount of movement deviates from this range.

The amount of movement between two images can be measured, for example, by identifying the elements present in the two images and measuring the norm of the displacement vectors of these elements. Movement measuring techniques are known. Among them, the technique called comparison of blocks between images is commonly used.

The individual quality factor of each image of a set of selected images demonstrates more or less the influence of this individual image on the overall quality of the lenticular grid hardcopy capable of being obtained.

Also an overall image quality factor is defined, capable of being calculated from the individual image quality factors. For example this is the simple sum or weighted sum of the individual image quality factors of a set of selected images. More generally this is a cumulative function of individual quality factors, such that the overall quality factor of an image set increases or decreases with the individual quality factor of each image of the set.

According to a particular implementation of the invention method the overall quality factor of the first set of selected images can be calculated explicitly. In this case, between steps c) and d) of the method the following is also planned:
the calculation of a new overall quality factor of each new set of selected images, and
the search, among the sets of selected images, for the set with the highest overall quality factor to prepare the printing data.

This implementation is preferably used when several images, or possibly all the images are replaced simultaneously during the selection of a new image set.

Another implementation option of the method can be envisioned especially when a single image is replaced at each new selection. According to this second implementation option, step c) comprises:

the selection of a new image in the shot sequence, the assignment to the new image of an individual quality factor, the comparison of the individual quality factor with the individual quality factor of an image of the previously selected image set, having to be replaced by the new image, and the replacement of the image having to be replaced by the new image when the individual quality factor of the new image is superior to that of the image having to be replaced.

This particular implementation of the method can also be envisioned when several images are replaced concurrently.

When several images are replaced, step c) comprises:

the selection of several new images in the shot sequence, the assignment to the new images of a common quality factor established based on the individual quality factors, the comparison of the common quality factor with the common quality factor of the images of the previously selected image set, having to be replaced by the new images, and the replacement of the images having to be replaced by the new images when the common quality factor of the new images is superior to that of the images having to be replaced. The common quality factor, is then similar to the overall quality factor, except that it only corresponds to a subgroup of the image set.

The fact of replacing one or more images every time by images whose quality factor is greater than that of the replaced images, guarantees that the last set of selected images necessarily has the highest overall quality factor, calculation of the overall quality factor not finally being essential.

So long as a gain of quality can be obtained, one image of a set of previously selected images is preferably replaced by an immediately neighboring image of the shot sequence. The fact of selecting an immediately neighboring image indeed allows the regular order of the selected images not to be significantly disturbed, and thus the natural character of the movement of the recorded scenes to be respected.

However, replacing one image of a selected set by another image that is not an immediately neighboring image can be envisioned. The effect of this is to introduce an acceleration or delay in the movement of the recorded scene. This solution is preferably only used if a significant quality gain can be obtained. Thus, when the new image is offset by a rank more than or equal to one, the replacement is only carried out if the quality factor of the new image is superior to that of the image to be replaced by an amount that is an increasing function of the offset rank. In other words, the greater the offset, the greater the quality gain must be to justify the image replacement.

When all the images of a previously selected set are replaced, precautions can also be taken to respect the movements of the recorded scene. For example, the new image set is selected with the same regular order O as that of the previously selected set, by choosing images respectively offset against the images of the previously selected set by a number of images less than the regular order O.

Other image selection criteria of an image set can be used. The images of an image set are for example selected so as to contain the same iconic element. The iconic element is for example a face, a geometric shape or a color range identified in several images.

The method can also comprise the selection of interest zones in the images and the replacements of images by images corresponding to the interest zones only. This amounts to reframing the images around the interest zones identified in them. This operation can be carried out directly on the images of the shot sequence or on the images of one or more sets of selected images.

Finally the invention relates to a camera comprising a selector control between a capture mode of a single fixed image and a capture mode of an image sequence, the camera also being equipped with a control for starting an automatic editing method as previously described, in response to the capture of a sequence where the number of images exceeds the number of images capable of being contained in a lenticular grid hardcopy.

Other characteristics and advantages of the invention will appear in the following description, with reference to the figures in the appended drawings. This description is given purely as an illustration and is not limiting.

### BRIEF DESCRIPTION OF THE DRAWINGS

FIG. 1 is an organization chart illustrating a method for shooting and editing video sequences to produce lenticular grid hardcopies, in accordance with the invention.

FIG. 2 represents a shot sequence and illustrates a first step of the method.

FIG. 3 shows a selection step of an image set in the sequence of FIG. 2.

FIG. 4 shows another selection of an image set in the sequence of FIG. 2.

FIG. 5 shows yet another selection of an image set in the sequence of FIG. 2.

FIG. 6 shows yet another selection of an image set in the sequence of FIG. 2.

FIG. 7 shows a camera adapted to implementing a method in accordance with the invention.

### DETAILED DESCRIPTION OF THE INVENTION

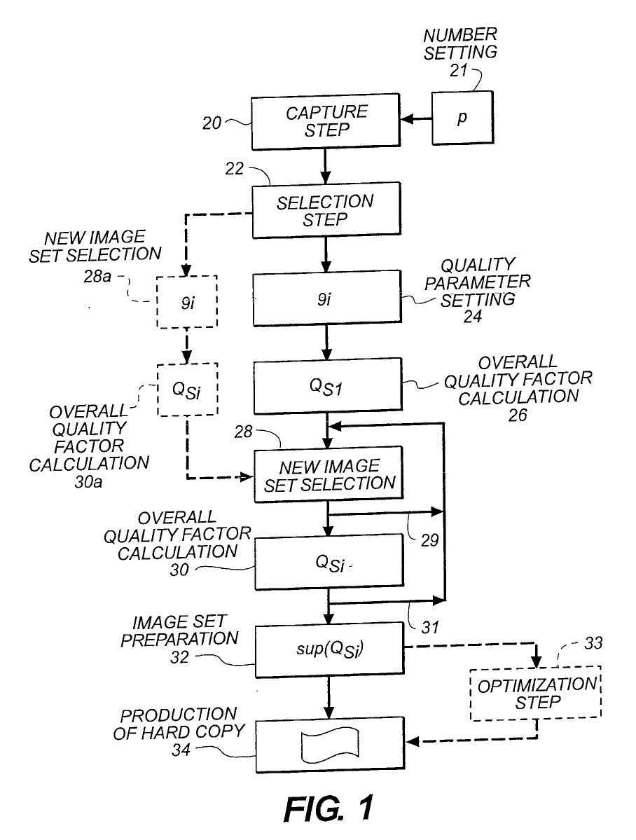

Reference 20 of FIG. 1 designates the capture of a shot sequence using a digital camera. Capture consists in saving the digital data of a regular succession of images, supplied by a sensor. In the following description, image data are simply designated by “images”, given that all the processing mentioned is performed on image data, up to the printing or manufacture of a hardcopy.

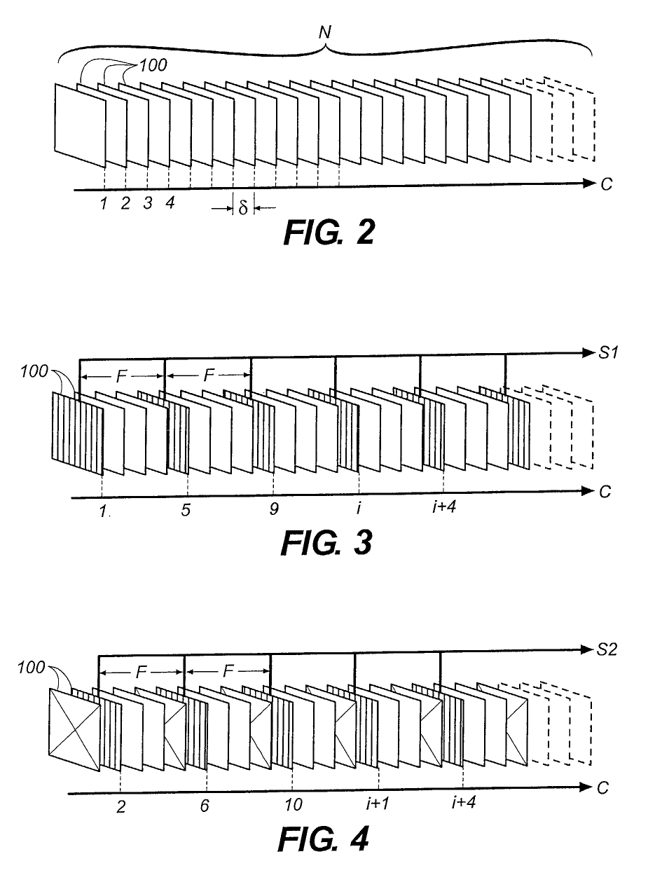

As FIG. 2 shows, the shot sequence supplied by the camera sensor comprises a succession of images 100. For clarity purposes of the figure, only a small number of images are represented. The number N of captured images essentially depends on the length of the sequence. Indeed the images are captured at a regular rate, for example, 24 images per second. An arrow c on the figure marks the chronological order of the successive images of the shot sequence. Two successive images are chronologically spaced by a more or less constant time 8.

Returning to FIG. 1, it may be noted that the shot capture 20 can be completed by the setting 21 of the number p of images that are wanted to manufacture a lenticular grid hardcopy.

While this is not a prerequisite for implementing the method, the editing method demonstrates its advantages when the number p is less than the number N of captured images in the shot sequence. The number of images p to be kept can be programmed in the camera. It can also be selected by the user if the camera offers a choice option enabling the number of images or rather the quality of the hardcopy to be favored. Finally it can be set by the hardcopy manufacturing equipment that the images are destined for.

In general, the number of images p is preferably between 10 and 30.

The second step 22 of the method consists in selecting a first set S1 of p images in the shot sequence. While this is not essential, the images are preferably selected in a regular order O. For example, one image is taken every F images, F being the whole part of the ratio of N over p.
F=int(N/p)

FIG. 3 illustrates one selection option of the first set of images S1. The selected images are represented with hatching. In this case it is the selection of one image out of four. Images 1, 5, 9, . . . i, i+4 etc. are selected. The letter i is used as a generic index. Respecting a regular order enables the time concordance of successive images to be preserved and thus the naturalness of a movement they are liable to represent.

Returning to FIG. 1, one step 24 consists in establishing for each image i of the selected set a quality parameter qᵢ. The quality parameter is for example fixed according to the sharpness of the images or a combination of the sharpness and the exposure. Other previously mentioned criteria can also be used.

A next step 26 consists in calculating a overall quality factor Q_{S1} for all the images of the first selected set. This is, for example, the sum of the individual quality factors qᵢ of the images.

$${Q}_{S 1} = {\sum }_{1}^{p} {q}_{i}$$

The next step 28 consists in selecting a new image set. This takes place after step 26 of the calculation of the overall quality factor of the first set, as the figure shows. It is also followed by the calculation 30 of an overall quality factor, according to the individual quality factors of the images of the new set.

FIG. 4 shows one selection option of the new set of images S2. In the illustrated example, each image is replaced by the immediately neighboring image and the next of the shot sequence. Image No. 1 is replaced by image No. 2, image i is replaced by image i+1 etc. The new overall quality factor, calculated for each new selection of images Si, based on the individual quality factors, is noted Q_{Si}. As the arrows 29 and 31 of FIG. 1 suggest, the steps of selection and possibly calculation of the overall quality factor can be repeated several times. With each selection of a new image set, a next rank of images can be retained. The method can be repeated until the return to the first selection by circular permutation. This enables, after the calculation of the overall quality factor of each selection, the set that will obtain the best quality hardcopy to be determined.

Indeed, the next step of the method, shown with the reference 32, consists in preparing image data for forming a lenticular grid hardcopy based on the selected image set whose overall quality factor is the highest. Step 32 can comprise the search, among the selected sets, for the set with the highest quality factor, noted Sup (Q_{Si}). All the operations that comprise the data formatting, the interlacing of the images of the selected set, its transmission to a hardcopy printing station and the production of the hardcopy itself, are represented on FIG. 1 by the single reference 34. These operations are not part of the editing method but constitute a possible follow on.

It should be noted that steps 28 and 30 consisting in selecting a new image set and calculating its overall quality factor are not necessarily performed following the calculation of the overall quality factor of the first set. In general, the selections of the various image sets can occur concurrently, or successively. The same goes for the calculation of the quality factors. On FIG. 1 references 28a and 30a designate the selection and calculation of the quality factor of a new image set that takes place at the same time as selection 24 and calculation 26 of the quality factor of the first set. This alternative is indicated by broken line.

The selection of a new image set can take place, as previously indicated with reference to FIG. 4, by replacing all the images of the previously selected set. It can also take place by only replacing a small number of images, or even a single image at a time.

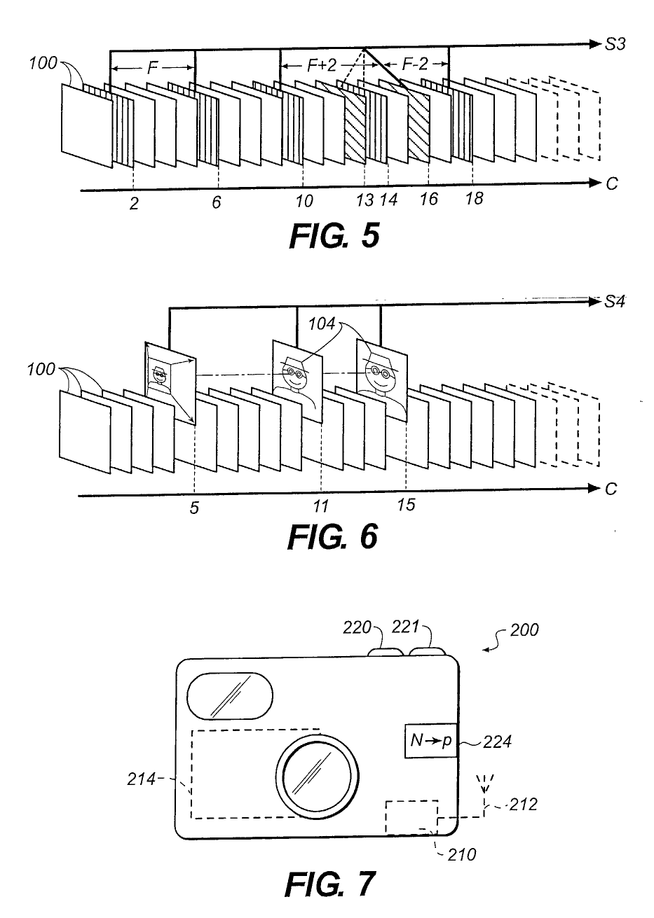

This is illustrated by FIG. 5. FIG. 5 shows a first image set comprising images Nos. 2, 6, 10, 14, 18, etc. indicated by horizontal hatching. This can be the first selected image set, a previously selected image set, or possibly the image set previously retained with the highest overall quality factor. In this case it is the image set already illustrated by FIG. 4.

The selection of a new image set takes place by replacing one of the images, in this case image No. 14 by image No. 13. The replacement can be preceded or followed by the calculation of the new overall quality factor so as to know which of the image sets should be retained. As an alternative, a comparison can take place between the individual quality factor of image No. 14 having to be replaced and that of image No. 13, candidate for the replacement. If it turns out that image 13 has an individual quality factor superior to that of image No. 14, or even if it exceeds that of image 14 by a certain amount, the replacement is carried out. In this case, the overall quality factor of the new set comprising image 13 in the place of image 14 is necessarily superior to that of the previous set, without it being necessary to calculate it.

The replacement of image 14 by image 13 only moderately disturbs the regularity of the sequence since it is an immediately neighboring image. Replacing one image of a previously selected set by an image that is not an immediately neighboring may also be envisioned. For example, this is image 16 of FIG. 5. The replacement of image No. 14 by image No. 16 in image set S3 creates a greater disturbance in the regularity of the recorded scene. This can be justified by a greater gain in the quality factor. For example, replacing a particularly fuzzy image by a sharper but clearly offset image can be envisioned. The quality factor of the new image should thus exceed that of the image to be replaced by a certain amount. This can be fixed so as to be an increasing function of the offset rank.

Replacement image-by-image, as described with reference to FIG. 5, can be performed during each selection of a new image set, i.e. during steps 24 and 28 mentioned with reference to FIG. 1. In this case the calculation of the overall quality factors in steps 26 and 30 can be omitted. Replacement image-by-image can also take place following step 32 when an image set with optimum regular offset has been determined as described with reference to FIG. 4. This amounts to adding an optimization step 33 into the diagram of FIG. 1. The optimization step 33 is indicated by a broken line.

During this step, the individual quality factors of all the previously retained images can be compared with the quality factors of the preceding and next images, of one or more ranks. If replacements of images by images of superior quality factor are possible, they are carried out. This operation can be systematically performed with all the previously selected images, i.e. images with horizontal hatching in FIG. 5. It can also be performed with only those among these images whose individual quality factor is low, i.e. less than a preset threshold value.

As FIG. 6 shows, the criterion of respecting a regular or more or less regular order of selected images is not essential to implementing the method. FIG. 6 shows the selection of a first image set S4 that is essentially based on the criterion of recognizing interest zones 104. The selection enables, as necessary, an interest zone with a face, or a particular iconic element to be retained, and other images of the shot sequence in which this face or this iconic element also appears to be searched for. The selection can be limited to objects that appear with a minimum size. The interest zone can also be enlarged and used to replace the image from which it is taken. This is the case of image No. 5 of FIG. 6.

FIG. 7 shows a camera 200 with a computer unit 210 programmed for the implementation of a method as previously described. The camera also includes a radio transmission unit, symbolized by an antenna 212 and intended to transmit data relating to a selected image set to equipment for producing lenticular grid hardcopies. On one unseen surface of the figure, the camera 200 comprises a monitoring screen 214 to preview the image set retained to produce a hardcopy.

A selector control 220, 221 is used to select either the capture of a single view with each release, or the capture of a shot sequence formed by many images. Two releases 220 and 221 are provided respectively. Finally, a single control 224 lets the user start the automatic editing method of a video sequence for the optimized production of a lenticular grid hardcopy. This editing takes place as previously described. The user can view on screen 224 the sequence obtained by the editing, and start or not the data transmission to produce a lenticular grid hardcopy.

Reference Document

(1) US 2003/0128287 A1

1) An automatic editing method of video sequences to produce lenticular grid hardcopies based on shot sequences produced by a digital camera, comprising
a) selecting a first set of images (S₁) in a shot image sequence,
b) selecting each image of the image set of an individual quality factor as a function of image characteristics,
c) selecting at least one new image set (S₂) by replacing at least one image of the previously selected image set by a new image of the shot sequence, and absent from the previously selected set, and
d) preparing image data to form a lenticular grid hardcopy, based on an image set taken from among the previously selected image sets and with the highest overall quality factor, the overall quality factor being a function of the individual quality factors of the images of each selected image set.

2) A method according to claim 1, further comprising calculating the overall quality factor of the first selected image set, and between steps c) and d) by:
calculating a new overall quality factor of each new set of images, and
searching, among the sets of selected images, for the set with the highest overall quality factor to prepare the printing data.

3) A method according to claim 1, wherein the images of the first image set respect a regular order of images of the shot sequence.

4) A method according to claim 3, wherein, during step c), the new image set is selected with the same regular order O as that of the previously selected set, by choosing images respectively offset against the images of the previously selected set by a number of images less than the regular order O.

5) A method according to claim 1, wherein step c) comprises:
the selection of several new images in the shot sequence, the assignment to the new images of a common quality factor established based on the individual quality factors, the comparison of the common quality factor with the common quality factor of the images of the previously selected image set, having to be replaced by the new images, and the replacement of the images having to be replaced by the new images when the common quality factor of the new images is superior to that of the images having to be replaced.

6) A method according to claim 1, wherein step c) comprises the selection of a new image in the shot sequence, the assignment to the new image of an individual quality factor, the comparison of the individual quality factor with the individual quality factor of an image of the previously selected image set, having to be replaced by the new image, and the replacement of the image having to be replaced by the new image when the individual quality factor of the new image is superior to that of the image having to be replaced.

7) A method according to claim 6, wherein the new image is an image immediately neighboring the image having to be replaced in the shot sequence.

8) A method according to claim 6, wherein the new image is offset from the image having to be replaced in the shot sequence by an offset rank more than or equal to one, and in which the image having to be replaced is replaced by the new image when the quality factor of the new image is superior to that of the image having to be replaced by an amount that is an increasing function of the offset rank.

9) A method according to claim 1, wherein the images of the first image set are selected so as to contain the same iconic element.

10) A method according to claim 1, comprising, the selection of interest zones in the images and the replacement of the images by new images corresponding to the interest zones.

11) A method according to claim 1, wherein the individual quality factor is fixed according to at least one characteristic taken from among the overall sharpness, the exposure, the centering in relation to an interest zone, the sharpness of the interest zone, the presence of human faces, and the amount of movement as against the neighboring images of the shot sequence.

12) A camera comprising a selector control between a capture mode of a single fixed image and a capture mode of an image sequence, the camera also being equipped with a single control operable to automatically edit a video sequence in response to the capture of a video sequence where the number of images exceeds the number of images capable of being contained in a lenticular grid hardcopy.
